(19) United States
(12) Patent Application Publication
(10) Pub. No.: US 2016/0217827 A1
(43) Pub. Date: Jul. 28, 2016

(54) METHOD AND APPARATUS FOR PROCESSING VIDEO STREAM

(71) Applicant: Electronics and Telecommunications Research Institute, Daejeon (KR)

(72) Inventors: Suk Hee CHO, Daejeon (KR); Sung Chang LIM, Daejeon (KR); Jong Ho KIM, Daejeon (KR); Hui Yong KIM, Daejeon (KR); Dae Yeol LEE, Daejeon (KR); Joo Young LEE, Daejeon (KR); Se Yoon JEONG, Daejeon (KR)

(21) Appl. No.: 15/005,354

(22) Filed: Jan. 25, 2016

(30) Foreign Application Priority Data
Jan. 28, 2015 (KR) 10-2015-0013615

(51) Int. Cl. G11B 27/034; H04N 19/593; H04N 19/70; H04N 19/105; H04N 19/44; H04N 19/177; H04N 9/804; H04N 19/503

(52) U.S. Cl. CPC G11B 27/034; H04N 9/8045; H04N 19/593; H04N 19/503; H04N 19/105; H04N 19/44; H04N 19/177; H04N 19/70

(57) ABSTRACT

Disclosed is a video stream processing method and apparatus that may identify a target picture to be edited among a I-picture and at least one B-picture subsequent to the I-picture, the I-picture and the at least one B-picture constituting a group of pictures (GOP) included in a video stream, and process the target picture, wherein pictures included in the video stream may be decoded in a playback order.

### CROSS-REFERENCE TO RELATED APPLICATION

This application claims the priority benefit of Korean Patent Application No. 10-2015-0013615, filed on Jan. 28, 2015, in the Korean Intellectual Property Office, the disclosure of which is incorporated herein by reference.

### BACKGROUND

1. Field of the Invention

Embodiments relate to a video stream processing method and apparatus that edits pictures sequence, and more particularly, to a video stream processing method and apparatus that easily edits pictures included in a video stream by configuring a group of pictures (GOP) included in the video stream with an intra coded picture (I-picture) and at least one bi-prediction coded picture (B-picture) referring to the I-picture.

2. Description of the Related Art

Pictures or video included in a video stream need to be edited to produce a broadcast program. A video stream refers to data including a plurality of pictures, and the pictures included in the video stream may be encoded using intra prediction or inter prediction. To edit an inter prediction based picture which refers to another picture, the picture which the corresponding picture refers to should be decoded together. Accordingly, although a relatively few number of pictures are edited, a computational complexity for decoding and encoding may considerably increase.

Recently, technology that applies intra prediction to all pictures included in a video stream is used to easily support editing on frame by frame basis. When all pictures included in the video stream are processed using intra prediction, a picture not to be edited does not need to be decoded or re-encoded. However, when all pictures are processed using intra prediction, a volume of the corresponding video stream may greatly increase, which is not suitable for a storage device with a restricted capacity.

### SUMMARY

An aspect provides a method and apparatus that may easily edit pictures and effectively increase an encoding efficiency by configuring a group of pictures (GOP) with an intra coded picture (I-picture) and at least one bi-prediction coded picture (B-picture) referring to the I-picture.

Another aspect also provides a method and apparatus that may output an editing result as an encoded video stream without performing re-encoding by configuring a GOP with an I-picture and at least one B-picture referring to the I-picture.

Still another aspect also provides a method and apparatus that may remove a computational complexity for re-encoding and enable fast processing when storing or outputting an editing result by outputting the editing result as an encoded video stream without performing re-encoding.

Yet another aspect also provides a method and apparatus that may encode a video stream in a prediction structure of ultra low delay by configuring a GOP with an I-picture and at least one B-picture referring to the I-picture.

According to an aspect, there is provided a video stream processing method including identifying a target picture to be edited among an intra coded picture (I-picture) and at least one bi-prediction coded picture (B-picture) subsequent to the I-picture, the I-picture and the at least one B-picture constituting a group of pictures (GOP) included in a video stream, and processing the target picture, wherein pictures included in the video stream may be decoded in a playback order.

Each of the at least one B-picture may be predicted by referring to the I-picture.

The processing may include decoding the target picture and a reference I-picture which the target picture refers to.

The processing may include setting a flag of the target picture and a flag of the reference I-picture as different values.

The target picture may be decoded and played back, and the reference I-picture may be decoded and not be played back.

A video stream including the processed target picture may be output, and the output video stream may include a flag indicating that a picture decoded and to not be played back is included.

The video stream may be encoded or decoded using high efficiency video coding (HEVC).

The I-picture may be decoded separately without referring to another picture.

According to another aspect, there is also provided a video stream processing apparatus including an identifier configured to identify a target picture to be edited among an I-picture and at least one B-picture subsequent to the I-picture, the I-picture and the at least one B-picture constituting a GOP included in a video stream, and a processor configured to process the target picture, wherein the pictures included in the video stream may be decoded in a playback order.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of a video stream;

FIG. 2 is a diagram illustrating a process of editing pictures included in a video stream;

FIG. 3 is a diagram illustrating an example of a video stream according to an embodiment;

FIG. 4 is a diagram illustrating a process of editing pictures included in a video stream according to an embodiment;

FIG. 5 is a diagram illustrating a pic_parameter_set syntax in high efficiency video coding (HEVC) according to another embodiment;

FIG. 6 is a diagram illustrating a slice_segment_header syntax in HEVC according to another embodiment;

FIG. 7 is a flowchart illustrating a video stream processing method according to an embodiment; and

FIG. 8 is a block diagram illustrating a configuration of a video stream processing apparatus according to an embodiment.

### DETAILED DESCRIPTION

Hereinafter, embodiments are described in detail with reference to the accompanying drawings. The following specific structural or functional descriptions are exemplary to merely describe the embodiments, and the scope of the embodiments is not limited to the descriptions provided in the present specification. Various changes and modifications can be made thereto by those of ordinary skill in the art. Further, like reference numerals refer to the like elements throughout the drawings, and a known function and configuration are not described herein.

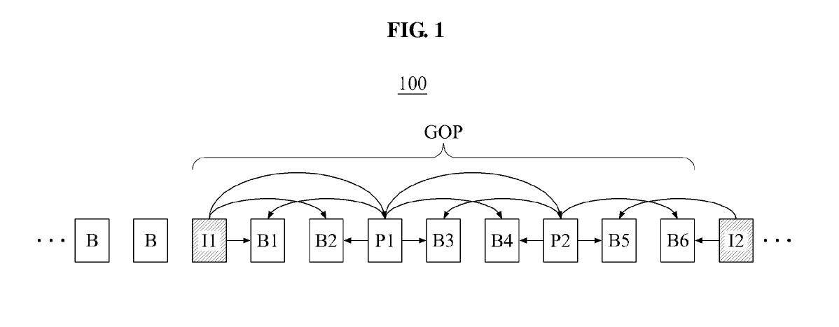

FIG. 1 is a diagram illustrating an example of a video stream.

A video stream 100 provided in a prediction structure illustrated in FIG. 1 includes intra coded pictures (I-pictures), predictive coded pictures (P-pictures), and bi-prediction coded pictures (B-pictures). The video stream 100 may include a plurality of pictures, and a picture is a basic unit of an image, for example, a single image frame. The video stream 100 may be a video stream to be encoded or decoded using moving picture expert group (MPEG) video coding such as advanced video coding (AVC).

The video stream 100 may include at least one of an I-picture, a P-picture, and a B-picture.

The I-picture may be encoded using intra prediction. All pixels in the I-picture may be encoded. The I-picture may be encoded based on the corresponding picture only. In detail, the I-picture refers to a picture that may be encoded separately without referring to another picture positions in a vicinity of the corresponding picture. Similarly, the I-picture may be decoded based on the corresponding picture only. The I-picture may be referred to by the P-picture or the B-picture.

The P-picture may be encoded using forward inter-picture prediction. The P-picture may be predicted by referring to a P-picture or an I-picture which is positioned temporarily in advance. Thus, the P-picture may include a less amount of information than the I-picture. Similarly, the P-picture may be decoded using forward inter-picture prediction.

The B-picture may be encoded using bi-inter-picture prediction, for example, forward prediction and backward prediction, two forward predictions, and two backward predictions. The B-picture may be predicted by referring to an I-picture or a P-picture which is positioned temporarily in advance, and an I-picture or a P-picture which is positioned temporarily behind. Thus, the B-picture may include a less amount of information than the I-picture and the P-picture. Similarly, the B-picture may be decoded using bi-inter-picture prediction.

The I-picture, the P-picture, and the B-picture may constitute a single group of pictures (GOP). The GOP is a set of successive pictures. In general, a GOP may include a single I-picture, at least one P-picture, and at least one B-picture. Thus, the GOP may include a single I-picture and pictures included in a period before a subsequent I-picture.

For example, a GOP of FIG. 1 may include I1, B1, B2, P1, B3, B4, P2, B5, and B6. In “I1”, “I” indicates that a corresponding picture is an I-picture, and “1” is an identification number assigned for ease of description to distinguish the corresponding I-picture from another I-picture. Further, arrows illustrated in FIG. 1 indicate relationships of referring to when predictions are performed. For example, a start point of an arrow indicates a reference picture of inter-picture prediction, and an end point of the arrow indicates a picture which is predicted by referring to the reference picture.

In detail, P1 is a P-picture which is predicted by referring to I1. To encode P1, I1 needs to be previously encoded. Similarly, to decode P1, decoding I1 needs to be previously performed. B5 is a B-picture which is predicted by referring to P2 and I2. Thus, to encode B5, P2 and I2 need to be previously encoded. Similarly, to decode B5, decoding P2 and I2 needs to be previously performed.

The GOP of FIG. 1 may be played back in an order of I1, B1, B2, P1, B3, B4, P2, B5, and B6. The GOP may be encoded or decoded in an order of I1, P1, B1, B2, P2, B3, B4, I2, B5, and B6.

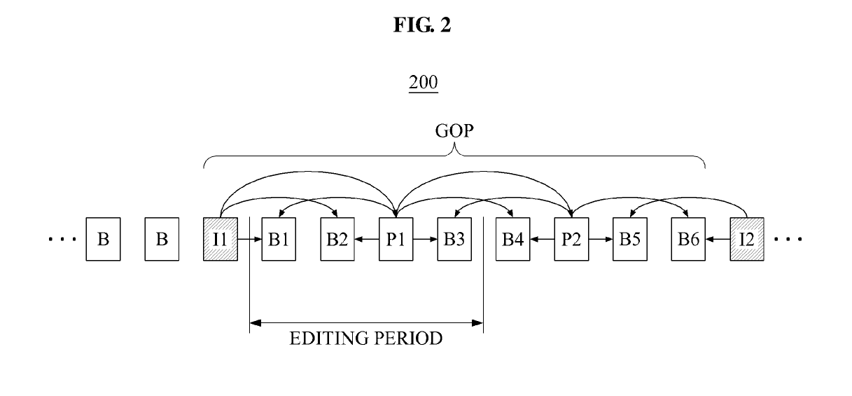

FIG. 2 is a diagram illustrating a process of editing pictures included in a video stream.

A video stream 200 provided in a prediction structure illustrated in FIG. 2 includes I-pictures, P-pictures, and B-pictures.

For example, a case that an editor wants to cut from B1 to B3 is assumed in FIG. 2. There are two processes in an editing, one is a play back to preview the result of editing and the other is generating output of the editing as a coded video stream.

In order to play back to preview the cut editing of the editing period 1, B1, B2, P1, and B3 need to be decoded. To decode B1, B2, P1, and B3, decoding I1 and P2 need to be performed together. In detail, to decode P1, decoding I1 needs to be previously performed. To decode B3, decoding P2 needs to be previously performed.

To generate the output of the cut editing in FIG. 2, the edited B1, B2, P1, and B3 need to be re-encoded to be a GOP having decodability. Where I1 and P2 need to be decoded to decode B1, B2, P1, and B3, but do not need to be re-encoded because I1, and P2 I1 and P2 are unnecessary for the output.

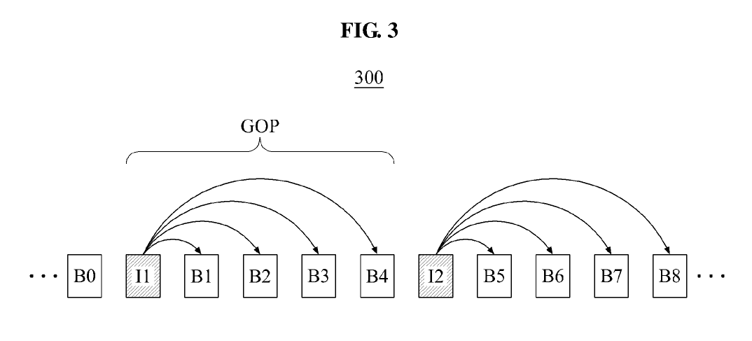

FIG. 3 is a diagram illustrating an example of a video stream according to an embodiment.

A video stream 300 provided in a prediction structure illustrated in FIG. 3 includes I-pictures and B pictures. The video stream 300 may be a video stream to be encoded or decoded using high efficiency video coding (HEVC).

An I-picture refers to a picture to be encoded or decoded using intra prediction, and may be the same as the I-pictures illustrated in FIG. 1. A B-picture refers to a picture to be encoded or decoded using inter prediction. For example, the B-picture may be a picture including the P-pictures and the B-pictures illustrated in FIG. 1.

However, the B-picture in FIG. 2 may be predicted by referring only to an I-picture which is nearest positioned temporarily in advance.

The video stream 300 may include GOPs, and each GOP may include an I-picture and at least one B-picture. The at least one B-picture included in each GOP may be predicted by referring to the I-picture included in the corresponding GOP. The I-picture included in each GOP may be disposed temporarily at a foremost position, among the pictures included in the corresponding GOP. The at least one B-picture may be predicted by referring to the I-picture which is positioned temporarily in advance.

For example, as shown in FIG. 3, one GOP may include I1, B1, B2, B3, and B4. I1 may be an intra prediction based I-picture. B1, B2, B3, and B4 may be B-pictures which are predicted by referring to I1. In detail, to decode or encode each B1, B2, B3, and B4, decoding or encoding I1 only needs to be previously performed, respectively.

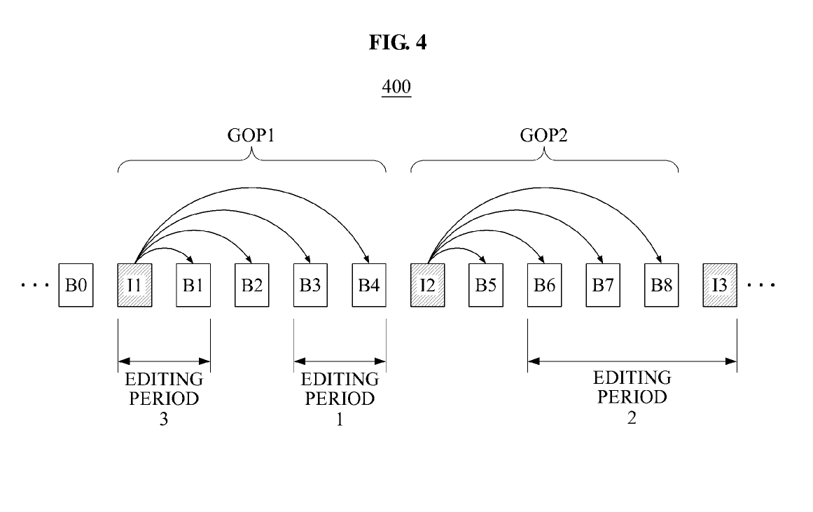

FIG. 4 is a diagram illustrating a process of editing pictures included in a video stream according to an embodiment.

A video stream 400 provided in a prediction structure illustrated in FIG. 4 includes I-pictures and B-pictures. For examples, there are three cases in FIG. 4.

First case is assumed a cut editing of the editing period 1, B3 and B4 in GOP1 in FIG. 2. Thus, B3 and B4 are target pictures to be edited. The target pictures B3 and B4 may refer only to I1. Thus, I1 may be a reference I-picture. Since B3 and B4 are B-pictures which refer only to I1, decoding I1 needs to be performed in advance of decoding B3 and B4. In detail, to edit B3 and B4, I1, B3, and B4 need to be decoded.

Second case is assumed that pictures included in different GOPs may be edited together such as the editing period 2 in FIGS. 4. B6, B7, B8, and I3 may be set as target pictures and edited. B6, B7, and B8 may be pictures which refer only to I2 and thus, I2 may be set as a reference I-picture. To decode B6, B7, and B8, decoding I2 needs to be previously performed. I3 is an intra prediction based I-picture and thus, any other picture does not need to be decoded together to decode I3. In detail, to edit B6, B7, B8, and I3, decoding I2, B6, B7, B8, and I3 may be performed.

For example, in a case of editing to cut and merge the editing period 1 and editing period 2 in FIG. 2 is assumed. To preview play of the editing result, I1, B3, and B4 corresponding to the editing period 1 may be decoded, and I2, B6, B7, B8, and I3 corresponding to the editing period 2 may be decoded, respectively. In detail the playing back, B3 and B4 may be played back and then, B6, B7, B8, and I3 may be played back only. That is, I1 and I2 are not played back. Third case is assumed a editing of the editing period 3 in FIG. 4. Thus I1 and B1 are target pictures. I1 may be an intra prediction based I-picture, and B1 is a B-picture which refers only to I1. Thus, I1 and B1 may be edited by decoding I1 and B1. In this case, the output of the edit result does not need any re-encoding.

Because the configuring of a GOP included in a video stream with an I-picture and at least one B-picture having only one reference picture as the I-picture such as FIG. 3. To decode any picture in the GOP needs at most additionally one reference picture decoding.

Further, the configuring of a GOP such as FIG. 3, there is no additional processing to play the GOP according to the displaying order. However, re-encoding may be still needed to generate the output of editing results.

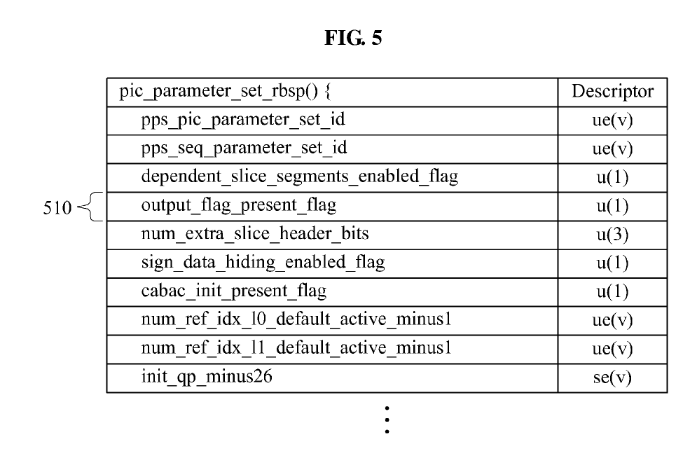

FIG. 5 is a diagram illustrating a pic_parameter_set syntax in HEVC according to another embodiment.

Referring to FIG. 5, a pic_parameter_set syntax defined in HEVC is illustrated. The pic_parameter_set syntax includes an output_flag_present_flag 510. The output_flag_present_flag 510 is a flag which indicates whether any picture to be decoded and not to be played is included in a video stream. For example, when a value of the output_flag_present_flag 510 is “1”, the video stream includes at least one picture to be decoded and not to be played. Conversely, when the value of the output_flag_present_flag 510 is “0”, the video stream does not include any picture to be decoded and not to be played. In detail, when the value of the output_flag_present_flag 510 is “0”, all pictures included in the video stream may be decoded and played back. Here, the video stream may be a video stream encoded using HEVC.

For example, in a case of editing B3 and B4 corresponding to the editing period 1 in FIG. 4 and outputting the editing result as an encoded video stream, the encoded video stream may include a flag which indicates that a picture to be decoded and not to be played back is included. In detail, the encoded video stream may include an output_flag_present_flag 510 having a value of “1”.

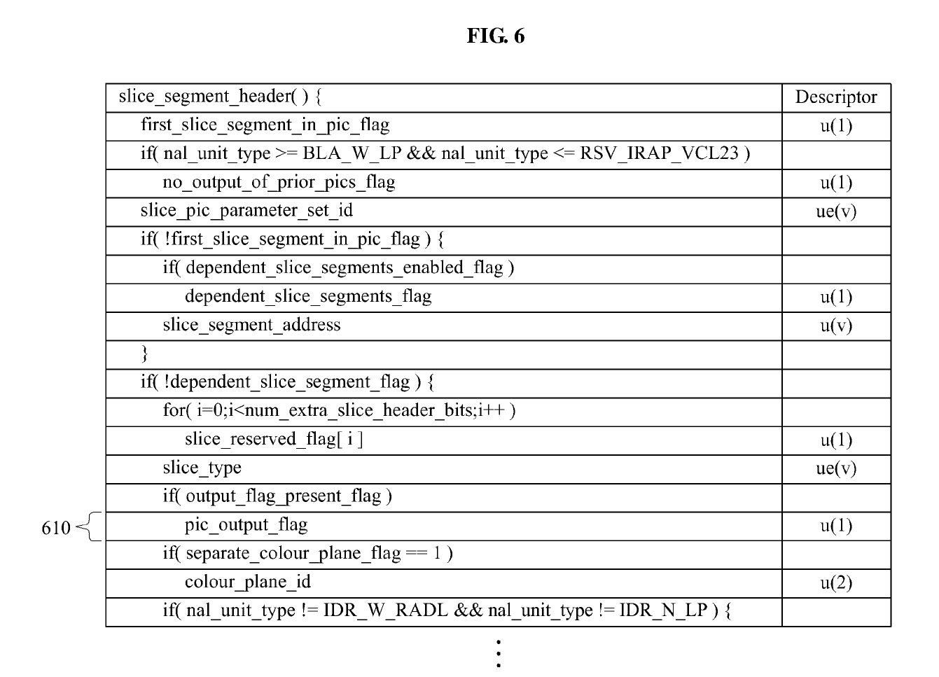

FIG. 6 is a diagram illustrating a slice_segment_header syntax in HEVC according to another embodiment.

Referring to FIG. 6, a slice_segment_header syntax defined in HEVC is illustrated. The slice_segment_header syntax includes a pic_output_flag 610. The pic_output_flag 610 is a flag which indicates whether a corresponding picture is a picture to be decoded and not to be played. For example, when a value of the pic_output_flag 610 is “0”, the corresponding picture may be decoded and shall not be played back. Conversely, when the value of the pic_output_flag 610 is “1”, the corresponding picture may be decoded and played back. Here, the picture may be a picture included in a video stream encoded using HEVC.

For example, in a case of editing B3 and B4 corresponding to the editing period 1 of FIG. 4 and outputting an editing result as an encoded video stream, a flag of I1 indicates that the corresponding picture is a picture to be decoded and not to be played. Flags of B3 and B4 indicate that the corresponding pictures are pictures decoded and played.

In another example, in a case of outputting a result of cut and merge editing the editing period 1 and the editing period 2 in FIG. 4, the entire editing period including the editing period 1 and the editing period 2 may be identified based on editing information. I1, B3, B4, I2, B6, B7, B8, and I3 may be decoded to preview. However the output encoded video stream may be extracted intactly from the original video stream. Here, I1, B3, B4, I2, B6, B7, B8, and I3 need not be re-encoded after decoded by using the output_flag_present_flag and pic_output_flags. Values of pic_output_flags 610 of I1 and I2 are set to “1”, and values of pic_output_flags 610 of B3, B4, B6, B7, B8, and I3 are set to “0”, respectively.

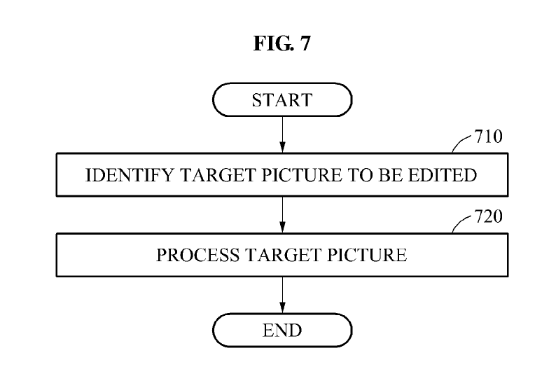

FIG. 7 is a flowchart illustrating a video stream processing method according to an embodiment.

The video stream processing method may be performed by a processor included in a video stream processing apparatus according to an embodiment.

Referring to FIG. 7, in operation 710, the video stream processing apparatus identifies a target picture to be edited among an I-picture and at least one B-picture constituting a GOP included in a video stream. The at least one B-picture may be positioned subsequent to the I-picture, and predicted by referring to the I-picture. The I-picture may be separately decoded or encoded without referring to another picture. The pictures included in the video stream may be decoded in a playback order. The video stream may be encoded or decoded using HEVC.

In operation 720, the video stream processing apparatus processes the target picture. The target picture may be a picture to be actually edited, and include at least one of the I-picture and the at least one B-picture.

To edit the target picture, the video stream processing apparatus may decode the target picture and a reference I-picture which the target picture refers to. In a case in which decoding the reference I-picture needs to be previously performed to decode the target picture, the video stream processing apparatus may decode the reference I-picture and then decode the target picture.

In a case of outputting an editing result as an encoded video stream, the video stream processing apparatus may set a flag of the target picture and a flag of the reference I-picture as different values. Accordingly, when playing back the encoded video stream, the target picture may be played back and the reference I-picture may not be played back. The output encoded video stream may include a flag which indicates that a picture to be decoded and not to be played back is included.

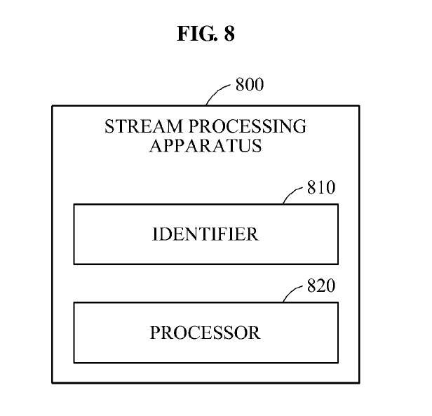

FIG. 8 is a block diagram illustrating a detail configuration of a video stream processing apparatus according to an embodiment.

Referring to FIG. 8, a video stream processing apparatus 800 includes an identifier 810 and a processor 820. The video stream processing apparatus 800 may be an apparatus for processing a video stream, and may be implemented using, for example, a software module, a hardware module, or a combination thereof. The video stream processing apparatus 800 may be provided in various computing devices and/or systems such as, for example, a smart phone, a tablet computer, a laptop computer, a desktop computer, a television, a wearable device, a security system, and a smart home system.

The identifier 810 identifies a target picture to be edited among an I-picture and at least one B-picture constituting a GOP included in a video stream. The at least one B-picture may be positioned subsequent to the I-picture, and predicted by referring to the I-picture. The I-picture may be separately decoded or encoded without referring to another picture. The pictures included in the video stream may be decoded in a playback order. The video stream may be encoded or decoded using HEVC.

The processor 820 processes the target picture. The target picture may be a picture to be actually edited, and include at least one of the I-picture and the at least one B-picture.

To edit the target picture, the processor 820 may decode the target picture and a reference I-picture which the target picture refers to. In a case in which decoding the reference I-picture needs to be previously performed to decode the target picture, the processor 820 may decode the reference I-picture and then decode the target picture.

In a case of outputting an editing result as an encoded video stream, the processor 820 may set a flag of the target picture and a flag of the reference I-picture as different values. Accordingly, when playing back the encoded video stream, the target picture may be played back and the reference I-picture may not be played back. The output encoded video stream may include a flag which indicates that a picture to be decoded and not to be played back is included.

According to an embodiment, pictures may be easily edited and an encoding efficiency may effectively increase by configuring a group of pictures (GOP) with an I-picture and at least one B-picture referring to the I-picture.

According to an embodiment, an editing result may be output as an encoded video stream without performing re-encoding by configuring a GOP with an I-picture and at least one B-picture referring to the I-picture.

According to an embodiment, a computational complexity for re-encoding may be removed and fast processing when storing or outputting an editing result may be enabled by outputting the editing result as an encoded video stream without performing re-encoding.

According to an embodiment, a video stream may be encoded in a prediction structure of ultra low delay by configuring a GOP with an I-picture and at least one B-picture referring to the I-picture.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A video stream processing method comprising:
identifying a target picture to be edited among an intra coded picture (I-picture) and at least one bi-prediction coded picture (B-picture) subsequent to the I-picture, the I-picture and the at least one B-picture constituting a group of pictures (GOP) included in a video stream; and
processing the target picture,
wherein pictures included in the video stream are decoded in a playback order.

2. The video stream processing method of claim 1, wherein each of the at least one B-picture is predicted by referring to the I-picture.

3. The video stream processing method of claim 1, wherein the processing comprises decoding the target picture and a reference I-picture which the target picture refers to.

4. The video stream processing method of claim 3, wherein the processing comprises setting a flag of the target picture and a flag of the reference I-picture as different values.

5. The video stream processing method of claim 3, wherein the target picture is decoded and played back, and
the reference I-picture is decoded and not played back.

6. The video stream processing method of claim 1, wherein a video stream including the processed target picture is output, and the output video stream comprises a flag indicating that a picture decoded and to not be played back is included.

7. The video stream processing method of claim 1, wherein the video stream is encoded or decoded using high efficiency video coding (HEVC).

8. The video stream processing method of claim 1, wherein the I-picture is decoded separately without referring to another picture.

9. A video stream processing apparatus comprising:
an identifier configured to identify a target picture to be edited among an intra coded picture (I-picture) and at least one bi-prediction coded picture (B-picture) subsequent to the I-picture, the I-picture and the at least one B-picture constituting a group of pictures (GOP) included in a video stream; and
a processor configured to process the target picture,
wherein the pictures included in the video stream are decoded in a playback order.

10. The video stream processing apparatus of claim 9, wherein each of the at least one B-picture is predicted by referring to the I-picture.

11. The video stream processing apparatus of claim 9, wherein the processor is configured to decode the target picture and a reference I-picture which the target picture refers to.

12. The video stream processing apparatus of claim 11, wherein the processor is configured to set a flag of the target picture and a flag of the reference I-picture as different values.

13. The video stream processing apparatus of claim 11, wherein the target picture is decoded and played back, and
the reference I-picture is decoded and not played back.

14. The video stream processing apparatus of claim 11, wherein a video stream including the processed target picture is output, and the output video stream comprises a flag indicating that a picture decoded and to not be played back is included.

15. The video stream processing apparatus of claim 9, wherein the video stream is encoded or decoded using high efficiency video coding (HEVC).

16. The video stream processing apparatus of claim 9, wherein the I-picture is decoded separately without referring to another picture.
